(19) United States
(12) Patent Application Publication
(10) Pub. No.: US 2013/0191729 A1
(43) Pub. Date: Jul. 25, 2013

(54) Method of Generating an Electronic Report

(71) Applicants: Rene Reinbigler, Kirchheim (FR); Jean-Louis Weissenbach, Ville (FR); Jean-Luc Beulay, Krautergersheim (FR); Subbarao Kattamuri, Lowell, MA (US)

(72) Inventors: Rene Reinbigler, Kirchheim (FR); Jean-Louis Weissenbach, Ville (FR); Jean-Luc Beulay, Krautergersheim (FR); Subbarao Kattamuri, Lowell, MA (US)

(73) Assignee: EMD MILLIPORE CORPORATION, Billerica, MA (US)

(21) Appl. No.: 13/637,047

(22) PCT Filed: Mar. 26, 2010
(86) PCT No.: PCT/EP2010/001940

§ 371 Date: Mar. 15, 2013

(51) Int. Cl. G06F 17/24

(52) U.S. Cl. CPC G06F 17/248
USPC 715/243

(57) ABSTRACT

In a method of processing data and generating an electronic report which can be printed on paper or displayed on a monitor screen, wherein the electronic report relates to operation characteristics of a system (1) which performs product manufacturing, processing and/or analysis steps and the data include a plurality of physical parameters which are characteristic of the operation of the system and are stored in a database (4), one of a plurality of report templates stored in a report template library (14) is selected. Each report template comprises at least one sub-report corresponding to a particular type of representation of data within an electronic report based on the respective report template (10) and including at least one data item, i.e. a reference to one of the physical parameters or to an arithmetic operation therewith and a static or dynamically assignable reference to a batch or time range. An electronic report based on the selected report template (10) and on the batches and/or time ranges associated with the respective data items is generated, stored in a report library (16), and printed (20) or displayed on a monitor (18).

The invention relates to a method of processing data and generating an electronic report which can be printed on paper or displayed on a monitor screen.

To operate and monitor systems, for example in a manufacturing environment, it is often required to present or visualize all kinds of data in an easily perceivable form, for example data related to physical parameters of the system or its components as a function of time.

It is known to provide solutions to this requirement on an individual basis for each component of the system. Because of the great variety of physical parameters and possible kinds of devices, it generally involves a large effort to set up proper visualization means and to handle the information provided. Each time the system is changed, much additional work is required to adapt the visualization means, in the sphere of the system devices as well as in relation to any interfaces.

It is an object of the invention to provide a method of processing and visualizing data, in particular data related to physical parameters of a system in a product manufacturing, processing and/or analysis environment, which is cost-effective, can be easily handled by a user and can be easily edited and adapted to changes of the system.

This object is achieved by the method of processing data and generating an electronic report which can be printed on paper or displayed on a monitor screen as defined in claim 1. Advantageous versions of the invention follow from the dependant claims.

In this method of processing data and generating an electronic report which can be printed on paper or displayed on a monitor screen, the electronic report relates to operation characteristics of a system which performs product manufacturing, processing and/or analysis steps. The data include a plurality of physical parameters which are characteristic of the operation of the system and which have been recorded by the system during operation thereof, have been set by an operator during operation of the system and/or are provided, independent of the system, by a user. These data are stored in a database with the physical parameters being stored as a function of time and batch. The term “batch” is used in a general sense, e.g. in the meaning of machine run, or relating to all samples produced or analyzed with the same batch number, etc.

According to the invention, one of a plurality of report templates stored in a report template library is selected, wherein each report template comprises at least one sub-report corresponding to a particular type of representation of data within an electronic report based on the respective report template and including at least one data item. Each data item comprises a reference to one of the physical parameters or to an arithmetic operation to be performed on at least one of the physical parameters and, moreover, a static or dynamically assignable reference to a batch or time range. The provision of an arithmetic operation to be performed on the physical parameter(s) is advantageous, e.g., when the physical parameter has to be converted from some machine format or when the physical parameter is not very meaningful in itself, but has to be used, optionally by inclusion of other physical parameters, to calculate a quantity which is more representative.

For each data item for which the reference to a batch or time range is dynamically assignable, the respective data item is associated with a respective particular batch or time range by assigning the respective reference to this batch or time range. This kind of dynamic assignment considerably increases the flexibility of the method.

Based on the selected report template and on the batches and/or time ranges associated with the respective data items, an electronic report is generated, which can be stored in a report library and can be printed or displayed on a monitor screen.

Thus, the method according to the invention can be easily applied and adapted to much different areas or applications by selecting, from a library, a report template appropriate to the task in question, which includes sub-reports related to the data items and their representation. The concept of the method is very modular, which results in a high flexibility and an appreciable cost reduction.

For each data item having a dynamically assignable reference to a batch or time range, the association of this data item with a batch or time range can be selected either by a user or can be performed automatically.

When the system comprises a plurality of devices, each report template stored in the template library can relate to one or more of these devices, wherein each sub-report can relate to one of these devices with each of the data items of a particular sub-report relating to one or more physical parameters which are characteristic of the operation of the corresponding device. In this case, for each device the physical parameters relating to that device can be stored in a separate area of the database. In particular, for each device the physical parameters recorded by the system or set by an operator during operation of the system, as well as the physical parameters provided independent of the system by a user and the arithmetic operations to be performed on at least one of the physical parameters can be stored in a separate sub-area of the database. In this way, there can be provided a clear assignment of report templates and sub-reports to devices of the system, which increases clarity and flexibility, facilitates operation and reduces cost.

Upon installing a new device in the system, a corresponding area can be automatically initialized within the database, and the new device can be automatically registered in and linked to the database such that physical parameters relating to that device are stored in the respective area.

When performing the method according to the invention, sometimes the report templates present in the report template library will not fit to the specific task in question. In this case, a new report template can be generated by creating a group of at least one sub-report, each corresponding to a particular type of representation of data within an electronic report based on the respective report template and including at least one data item. As before, each data item comprises a reference to one of the physical parameters or to an arithmetic operation to be performed on at least one of the physical parameters as well as a static or dynamically assignable reference to a batch or time range. It is also conceivable to include in the group a kind of sub-report not containing data items (for example text blocks or pictures) or containing data items not relating to physical parameters or having data items comprising an arithmetic operation being a constant, which otherwise can be handled like a sub-report. The report template including the sub-reports from that group is stored within the report template library.

Creating the group of at least one sub-report can comprise the steps of selecting at least one predetermined sub-report stored in a sub-report library and adding the selected sub-reports to the group. (The kind of sub-reports including, e.g., text blocks can also be loaded from the sub-report library.) When the system comprises a plurality of devices, upon installing the devices in the system, at least one predetermined sub-report relating to the respective device can be automatically provided from the respective device to the sub-report library and stored therein. In this way, the system automatically adjusts to the inclusion of an additional device.

In advantageous embodiments of the invention, creating the group of at least one sub-report comprises the steps of generating at least one new sub-report and adding at least one of the new sub-reports to that group. A new sub-report is generated by selecting a sub-report template stored in a sub-report template library and corresponding to a particular type of representation of data within an electronic report based on the new report template, by adding at least one data item to the sub-report to be represented in accordance with the type of representation corresponding to the sub-report, by setting, for each data item, a reference to one of the physical parameters available in the database or to an arithmetic operation to be performed on at least one of the physical parameters available in the database, by setting, for each data item, a static reference to a particular batch or time range or defining a dynamically assignable reference to a batch or time range, and by storing the sub-report including the added data items within a sub-report library.

Upon installing each of the devices in the system, at least one predetermined sub-report template relating to the respective device can be automatically provided from the respective device to the sub-report template library and stored therein.

In performing the method according to the invention, the sub-reports from the group of sub-reports can be ordered, wherein the order of the sub-reports determines the order of the corresponding representations of data within an electronic report based on the new report template.

In the following, the invention is further described by means of embodiments. The figures show in

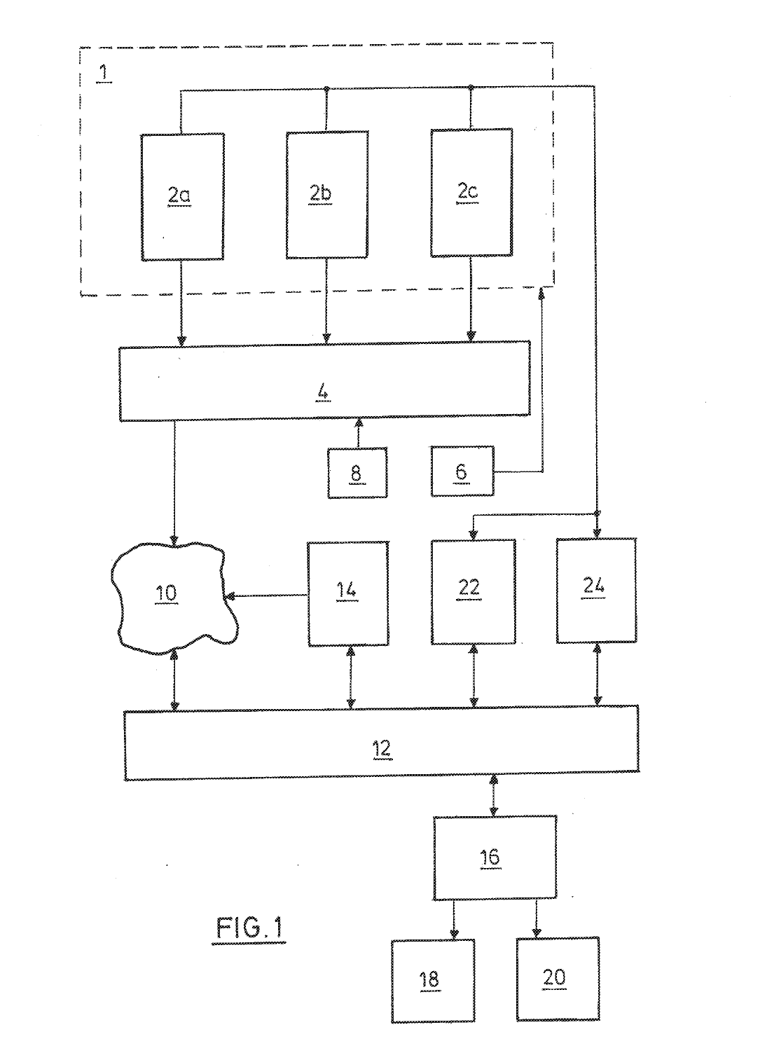

FIG. 1 a schematic block diagram of a system delivering data and of the main components for performing an embodiment of the method according to the invention of processing data and generating an electronic report relating to operation characteristics of the system,

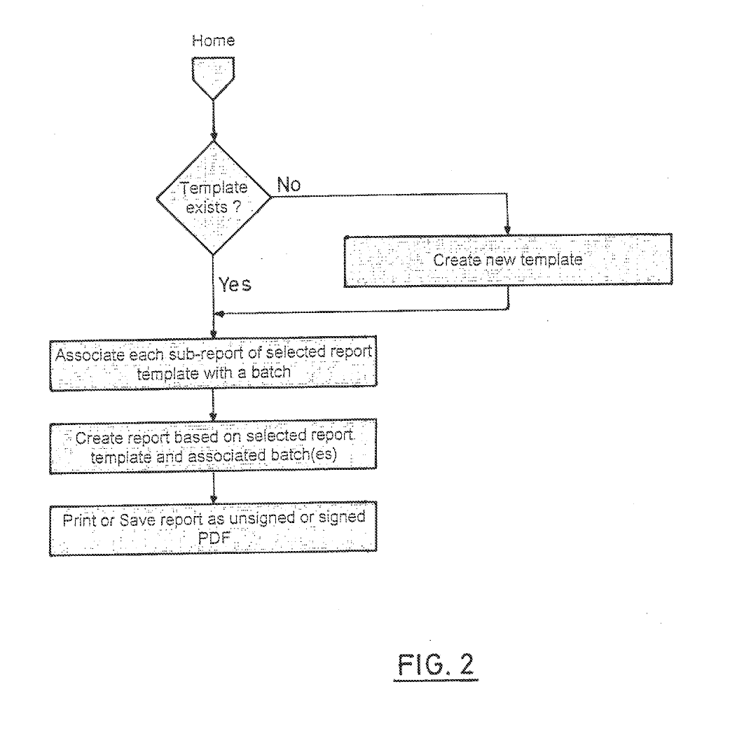

FIG. 2 a schematic flowchart illustrating the essential steps in performing the method and

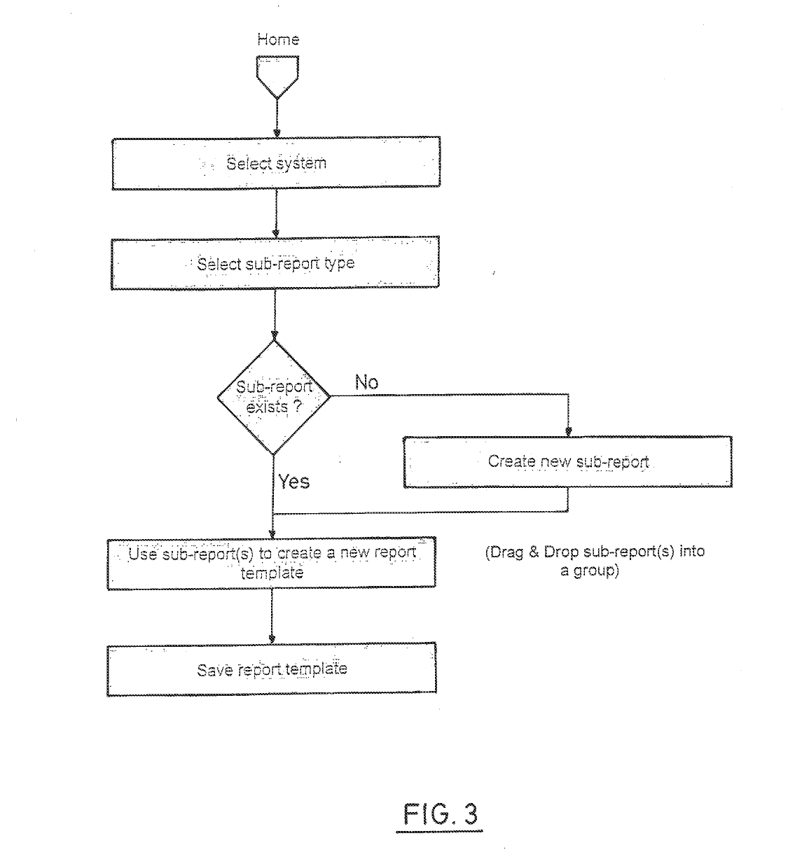

FIG. 3 a schematic flowchart illustrating the essential steps for creating a new report template.

The method according to the invention of processing data and generating an electronic report relating to operation characteristics of a system which performs product manufacturing, processing and/or analysis steps as well as the advantages of the method have already been explained before. In the following, some essential points are further elucidated by more specific embodiments.

FIG. 1 displays, in a diagrammatic view, the environment and the essential components and steps for performing an embodiment of the method.

In this embodiment, a system 1 for product manufacturing includes three devices 2a, 2b and 2c. The devices 2a, 2b, 2c deliver data, in particular data relating to physical parameters which are characteristic of the operation of the system, which are recorded by the system 1 and are stored in a database 4. Further data can be entered by a system operator 6 (who usually is close to the system 1) and also by a more remote user 8 (who, e.g., enters the data directly to the database 4). The arrows in FIG. 1 symbolize the main data streams. In general, any components for operating and controlling the system 1 are not shown in FIG. 1, because the method to be illustrated is used to monitor and visualize the data and not to directly control the system 1.

The main tool of the method is a report template 10. A user can select, via a user interface 12, a specific report template 10 from a report template library 14. The report template 10 comprises at least one sub-report corresponding to a particular type of representation of data within the electronic report to be generated by means of the selected report template 10. The sub-report includes at least one data item which designates the physical parameter to be represented or refers to some arithmetic operation to be performed on one or more than one of the physical parameters. The sub-report also includes a static or dynamically assignable reference to a batch (e.g., machine run number) or time range. In other word, the sub-report tells the report template which parameter is to be represented and how it is to be represented and involves, e.g., address information on the range of the data to be considered.

For each data item for which the reference to a batch or time range is dynamically assignable, the respective data item is associated with a respective particular batch or time range by assigning the respective reference to said batch or time range. This step is usually performed via the user interface 12.

Finally, an electronic report based on the selected report template and on the batches and/or time ranges associated with the respective data items is generated and stored in a report library 16. The report can be displayed on a monitor 18 or sent to a printer 20.

Sometimes it will be required to create a new report template or to edit an existing one. In this case, appropriate sub-reports can be loaded from a sub-report library 22 and arranged into a new report template, which is added to the report template library 14. If there is no appropriate sub-report available in the sub-report library 22, a sub-report can be generated by means of a sub-report template selected from a sub-report template library 24.

Sub-reports and sub-report templates can be added to the libraries 22 and 24, respectively, in a convenient way, when, upon installing a device 2a, 2b or 2c in system 1, at least one predetermined sub-report or sub-report template relating to the respective device is automatically provided from the respective device to the sub-report library 22 or the sub-report template library 24 and stored therein.

In the following, some sequences of the method are explained in more detail.

FIG. 2 illustrates the essential steps in performing the method by means of a schematic flowchart.

In order to generate an electronic report, the user interface 12 is started (“Home”) and the required report template 10 is selected from the report template library 14 (“Template exists? Yes”). In the next step, each sub-report of the selected report template 10 is associated with a batch. This can be done, e.g., by selecting a specific batch number of available batch numbers, e.g. from a drop list, and can be repeated for each sub-report. Depending on the data item considered, a time range could be used instead of a batch number. Based on this input, the report can be created. Finally, it can be printed or saved, e.g. as an unsigned or as a signed pdf file.

For of a batch or time range, it can be advantageous to focus on a defined time period by means of markers. In that case, when the report is created, the information considered is limited to the time frame provided by the marker. The marker time frame can be automatically or manually set during operation of the system.

The right-side branch in FIG. 2 relates to the situation when a new report template has to be created. This can be done by arranging existing sub-reports from the sub-report library 22 to a new group of sub-reports, which results in the desired report template, see FIG. 3.

In case a required sub-report does not exist, it has to be generated. To this end, the sub-report templates stored in the sub-report template library 24 may be useful. These templates can be automatically entered into the sub-report template library 24 when the devices 2a, 2b, 2c are installed.

For example, after selecting the system device considered and the type of new sub-report needed and after entering a name for the new sub-report, lists containing available physical parameters (e.g., pressures at two different locations) and lists containing offered calculations involving these parameters (e.g. the difference of said two pressures) are opened so that the user can select the desired parameters and arithmetic operations. Further inputs relate to the data qualifiers, i.e. the static or dynamically assignable references to a batch or time range (e.g., last batch as dynamic assignment, static batch number as static assignment to be entered). Moreover, the kind of representation of the data can be considered, e.g. by leaving default parameters unchanged or by optionally selecting different values for the parameters (e.g. for the scale and color of graphical curves). In this way, the essential features of a sub-report, i.e. the type of representation of data and the data items (reference to physical parameter/arithmetic operation, reference to batch/time range) are defined. Finally, the new sub-report is saved in the sub-report library 22.

In a sub-report, by using different data qualifiers to display elements, it can be possible to compare batches in different time periods. This function is useful, e.g., to compare a batch against a reference batch.

In an advantageous embodiment, the sub-reports required to set up a new report template can be conveniently collected/grouped in a working area of the user interface 12 by applying the drag-and-drop function. As additional steps for constructing a report template, the order of the sub-reports can be rearranged, and a header and a footer can be entered. Optionally, it is possible to lock (i.e., prevent from further editing), to approve (e.g., by an electronic signature) and/or to preview the sub-reports or the report templates created or to convert them into a different file format, depending on the particular type of representation.

1. A method of processing data and generating an electronic report which can be printed on paper or displayed on a monitor screen, wherein
said electronic report relates to operation characteristics of a system (1) which performs product manufacturing, processing and/or analysis steps,
said data include a plurality of physical parameters which are characteristic of the operation of said system and which have been recorded by said system during operation thereof, have been set by an operator (6) during operation of said system and/or are provided independent of said system by a user (8), and
said data are stored in a database (4) with the physical parameters being stored as a function of time and batch,
said method further comprising the steps of:
(a) selecting one of a plurality of report templates stored in a report template library (14), wherein each report template comprises at least one sub-report corresponding to a particular type of representation of data within an electronic report based on the respective report template (10) and including at least one data item, each data item comprising
a reference to one of said physical parameters or to an arithmetic operation to be performed on at least one of said physical parameters and
a static or dynamically assignable reference to a batch or time range,
(b) for each data item for which the reference to a batch or time range is dynamically assignable, associating the respective data item with a respective particular batch or time range by assigning the respective reference to said batch or time range,
(c) generating an electronic report based on the selected report template (10) and on the batches and/or time ranges associated with the respective data items,
(d) optionally storing the generated report in a report library (16), and
(e) printing (20) the generated report or displaying it on a monitor screen (18).

2. The method as claimed in claim 1, wherein for each data item having a dynamically assignable reference to a batch or time range the association of said data item with a batch or time range is either selectable by a user or performed automatically.

3. The method as claimed in claim 1 or claim 2, wherein said system (1) comprises a plurality of devices (2a, 2b, 2c) and each report template stored in the report template library (14) relates to one or more of said devices, wherein each sub-report relates to one of said devices with each of the data items of a particular sub-report relating to one or more physical parameters which are characteristic of the operation of the corresponding device.

4. The method as claimed in claim 3, wherein for each device (2a, 2b, 2c) the physical parameters relating to that device are stored in a separate area of said database (4).

5. The method as claimed in claim 4, wherein for each device (2a, 2b, 2c) the physical parameters recorded by said system (1) or set by an operator (6) during operation of said system, the physical parameters provided independent of said system by a user (8), and said arithmetic operations to be performed on at least one of said physical parameters are stored in a separate sub-area of said database (4).

6. The method as claimed in claim 4 or claim 5, wherein upon installing a new device (2a, 2b, 2c) in said system (1) a corresponding area is automatically initialized within said database (4), and the new device is automatically registered in and linked to said database such that physical parameters relating to said device are stored in the respective area.

7. The method as claimed in any of the preceding claims, further comprising the step of generating a new report template, said step including
(a) creating a group of at least one sub-report, each corresponding to a particular type of representation of data within an electronic report based on the respective report template and including at least one data item, each data item comprising
a reference to one of said physical parameters or to an arithmetic operation to be performed on at least one of said physical parameters and
a static or dynamically assignable reference to a batch or time range, and
(b) storing the report template including the sub-reports from said group within said report template library (14).

8. The method as claimed in claim 7, wherein creating said group of at least one sub-report comprises the steps of selecting at least one predetermined sub-report stored in a sub-report library (22) and adding the selected sub-reports to said group.

9. The method as claimed in claim 8 and any of claims 3 to 6, wherein upon installing each of said devices (2a, 2b, 2c) in said system (1) at least one predetermined sub-report relating to the respective device is automatically provided from the respective device to said sub-report library (22) and stored therein.

10. The method as claimed in any of claims 7 to 9, wherein creating said group of at least one sub-report comprises the steps of generating at least one new sub-report and adding at least one of said new sub-reports to said group, wherein a new sub-report is generated by
(a) selecting a sub-report template stored in a sub-report template library (24) and corresponding to a particular type of representation of data within an electronic report based on the new report template,
(b) adding at least one data item to the sub-report to be represented in accordance with the type of representation corresponding to the sub-report,
(c) for each data item setting a reference to one of said physical parameters available in said database (4) or to an arithmetic operation to be performed on at least one of said physical parameters available in said database,
(d) for each data item setting a static reference to a particular batch or time range or defining a dynamically assignable reference to a batch or time range,
(e) storing the sub-report including the added data items within a sub-report library (22).

11. The method as claimed in claim 10 and any of claims 3 to 6, wherein upon installing each of said devices (2a, 2b, 2c) in said system (1) at least one predetermined sub-report template relating to the respective device is automatically provided from the respective device to said sub-report template library (24) and stored therein.

12. The method as claimed in any of claims 7 to 11, further including the step of ordering the sub-reports from said group, wherein the order of said sub-reports determines the order of the corresponding representations of data within an electronic report based on the new report template.
